(19) United States
(12) Patent Application Publication
(10) Pub. No.: US 2026/0058035 A1
(43) Pub. Date: Feb. 26, 2026

(54) HIGH VOLTAGE POWER CONDUCTOR ASSEMBLY INCLUDING AN INTERNAL COOLANT CHANNEL AND INNER SURFACE HEAT TRANSFER PROTRUSIONS

(71) Applicant: Aptiv Technologies AG, Schaffhausen (CH)

(72) Inventors: Jan WOLNY, Kraków (PL); Monika PIESZKA, Kraków (PL); Pawel KOZAK, Kraków (PL)

(21) Appl. No.: 19/309,856

(22) Filed: Aug. 26, 2025

(30) Foreign Application Priority Data
Aug. 26, 2024 (EP) 24196464.2

(51) Int. Cl. H01B 7/42; H01B 17/58

(52) U.S. Cl. CPC H01B 7/426; H01B 7/423; H01B 17/58

(57) ABSTRACT

A high voltage power conductor assembly includes a tubular electrical conductor having an inner surface with protrusions that define a channel for receiving coolant from a cooling system to remove heat from the conductor, and an outer insulation surrounding the tubular electrical conductor. The protrusions increase surface area and promote turbulence of coolant flow within the channel, enhancing heat transfer from the conductor to the coolant. The outer insulation electrically isolates the conductor while allowing efficient heat evacuation, thereby improving thermal management in high voltage applications.

### CROSS-REFERENCE TO RELATED APPLICATION

This application claims the benefit of and priority to European Application No. 24196464.2 filed with the European Patent Office on Aug. 26, 2024, the contents of which are incorporated by reference herein.

### TECHNICAL FIELD

The present disclosure generally relates to high voltage power conductor assemblies, and more particularly, to a power conductor assembly configured for coupling to a coolant system and which can incorporate such an integrated coolant system.

### BACKGROUND

Charging of high voltage batteries, for example in the field of automotive technology, requires the use of heavy gauge high voltage (HV) power conductor assemblies that can handle the level of current required to ensure fast charging. The HV power conductor assemblies used in battery charging applications and/or power distribution applications are often provided with a cooling system to ensure that the heat generated at the electrical conductor due to the high current flow is dissipated away, thereby increasing the efficiency and safety of the charging operation.

Passive cooling solutions have been applied to reduce the temperature dissipated by a HV power connector assembly. However, passive cooling solutions are limited due to manufacturing and weight constraints. For example, changing the dimensions of the components, e.g. increase the electrical conductor gauges, to reduce temperature would increase the weight and cost of the power cable assembly, while reducing its flexibility.

Cable cooling systems are also known, for example one described in WO 2018/60151, having a plug-in connector part for plug-in connection to a mating connector part of the electric vehicle. The system further includes a charging cable on which the plug-in connector part is arranged and which includes at least one load line for transmitting an electrical current and at least one fluid line for guiding a gaseous fluid for cooling the charging cable and the plug-in connector part arranged on the charging cable. A conveyor device is fluidically connected to the at least one fluid line, for conveying a gaseous fluid into the at least one fluid line A charging system is thereby provided, which allows cooling using a gaseous fluid.

However, none of these approaches have provided a comprehensive solution that combines the features described in this disclosure.

### SUMMARY

The above-mentioned objects are at least partially realized by a high voltage power conductor assembly and a method of cooling a high voltage power conductor assembly disclosed herein.

An aspect of the disclosure relates to a high voltage power conductor assembly including a tubular electrical conductor and an outer insulation surrounding the tubular electrical conductor. The tubular electric conductor can have different cross-sections, depending on the circumstances, as long as it is tubular, i.e. the conductor has a hollow interior space. Within the interior space, the tubular electrical conductor has an inner surface with protrusions intended to increase heat transfer. With protrusions the contact surface with the content of the interior space is increased, which in turn increases the heat transfer from the conductor to the content of the channel. The inner surface defines a channel which can receive a coolant from a cooling system designed to evacuate heat from the conductor to the coolant when in use.

The protrusions can be of different nature such as in form of a coarse inner surface, a patterned surface with protruding dots, waves, etc. In a preferred embodiment however, at least part of the protrusions are fins, preferably linear fins in the extension direction of the tubular electrical conductor. Fins can easily and economically be produced by drawing the tubular electrical conductor. When the fins extend in the main direction of the tubular electrical conductor, the fins also follow the heat gradient within the electrical conductor, which additionally improves the heat transfer performance.

In cross-section, the fins can have a triangular shape. The fins could in particular also have a circular triangular cross-section or a negatively curved triangular cross section. Rectangular, zig-zag shapes or wave-like shapes are also possible. All of these arrangements increase the heat-exchanging surface while keeping enough solid material to ensure good heat transfer performance.

To ensure a good heat transfer while keeping the extra material required low, at least 10 fins should be disposed on the inner surface of the tubular conductor. The heat transfer performance can be further enhanced by having between 30 and 200 fins, and even more enhanced by having between 60 and 200 fins. Generally, the number of fins depends on the diameter of the conductor, whereby the performance of the conductor assembly does not improve beyond a given threshold of fin which depends on the diameter.

Similarly, also the height with which the fins protrude from the inner surface of the electrical conductor has an influence on the heat exchanging surface. A significant increase in the heat exchanging surface is obtained with a height of at least 0.2 mm. The heat transfer performance can be further enhanced by having a height of at least 0.4 mm, and even more at a height of at least 0.6 mm. However, increasing the height of fin doesn't improve heat transfer indefinitely. At some point the fin's tip reaches the temperature of the fluid and increasing the height will not improve the heat transfer anymore since there is no temperature difference between the fin and the fluid. As such, the height of the fin is a parameter that needs to be optimized depending on the application, considering fluid type, temperature, current carried by the conductor, conductor internal diameter etc.

A good relation dᵢ/h between the inner diameter [dᵢ] of the tubular conductor and the height with which the linear fins protrude from the inner surface of the electrical conductor has proven to be between 8 and 100. Within these boundaries the conducting properties match the cooling properties. This means that the coolant amount does not exceed what is needed for good power conduction. Power conduction performance can be further enhanced by having a relation dᵢ/h between 10 and 75 and even more having a relation dᵢ/h between 10 and 50.

As an example: a relation dᵢ/h of 40 means that the protruding height of a fin is 40 times larger than the inner diameter. For example, with a fin height of 0.5 mm, the inner diameter would be 20 mm.

The high voltage power conductor assembly conveniently includes a coolant system and a coolant within the channel. The coolant system is configured to allow the coolant to circulate within the channel to evacuate heat produced by the conductor in use. The coolant system may for example be provided with a heat exchanger to effectively transfer the heat taken up by the coolant from the conductor assembly to the environment.

When the inner surface of the tubular electrical conductor is insulated, coolants including water, glycol and/or similar materials or combinations thereof can be used. These have the advantage of being unexpensive. In case the tubular electrical conductor is not insulated, dielectric coolants such as for example hydrofluoethers (HFE) have proven to evacuate heat efficiently. The type of coolant is conveniently chosen considering the system architecture, such as dimensions, maximum voltage power, etc.

Good heat evacuation is obtained when the coolant circulates at a flow rate of at least 0.5 l/min, more preferably at least 1.5 l/min, even more preferably at least 3 l/min. An exact flow rate will, of course, depend on the application and the diameter of the conductor.

The coolant system can further include an inlet on a first end of the channel and an outlet on a second end of the channel and the inlet, and the outlet may be configured to allow a steady flow of coolant.

Additionally, the inlet and/or the outlet may include means to selectively regulate the flow rate of the coolant. The flow rate can then be adapted to the current flow in the tubular electrical conductor such that the heat exchange is optimized for each charging configuration.

The conductor can be made of known conductive material such as high conductivity copper alloys, copper or aluminum. The wall thickness of conductor can thereby be chosen between 0.5 mm and 20 mm, preferably between 0.7 mm and 10 mm, more preferably between 0.9 mm and 5 mm to ensure sufficient power conduction properties and ultimately a sufficient charging rate.

The protrusions are conveniently integrally formed with the conductor when the conductor itself is produced. This is a cost-effective way of adding protrusions as no extra production step is needed. For example, when the tubular electrical conductor is produced, for example as formed and welded steel tubes or as seamless, hot-rolled or drawn tubes, the inner protrusions are simultaneously produced, and no extra production step is needed.

According to another aspect of the disclosure, a method of cooling a high voltage power conductor assembly while charging a battery, in particular while charging an electric vehicle, is disclosed. The method includes the steps of providing a high voltage power conductor assembly and connecting it to a battery and an electricity source such that the connected battery can be charged. To evacuate heat produced in the tubular electrical conductor, a coolant system is connected in a way that a dielectric coolant can circulate within a channel of the tubular electrical conductor.

Thereby, the coolant system can be connected to the tubular electrical conductor through an inlet and an outlet located at the ends of the channel to a coolant supply. For best heat evacuation performance, it is preferable to include means to regulate the flow rate of the coolant to adapt it to the current flow in the electrical conductor.

### BRIEF DESCRIPTION OF THE DRAWINGS

FIG. 1 shows the cross-section of a high voltage power conductor assembly according to some embodiments.

FIG. 2 shows an isometric view of the high voltage power conductor assembly of FIG. 1 according to some embodiments.

### DETAILED DESCRIPTION

In the following, preferred embodiments of the present disclosure are described in detail with respect to the figures.

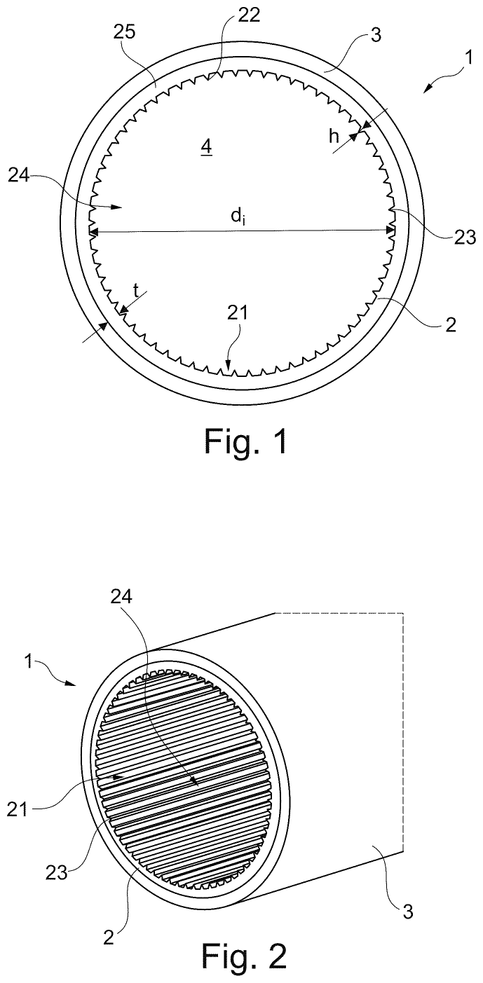

FIG. 1 shows a cross-sectional view of an embodiment of a high voltage power conductor assembly 1. A tubular electrical conductor 2 is surrounded by an outer insulation 3 and includes a channel 24 therein. Channel 24 is defined by an inner surface 21 of the tubular conductor 2. The tubular conductor 2 is made from an electroconductive material to conduct electricity, in particular for high voltage applications, like charging the batteries of an electric or hybrid vehicle. The channel is supposed to be filled with a dielectric coolant 4 which coolant is associated with a coolant system (not shown) designed to evacuate heat from the electrical conductor. The dielectric coolant preferably flows through channel 24 and is circulated through a heat exchanger to dissipate the heat taken up from the electrical conductor 2.

The tubular electrical conductor 2 is preferably provided in form of a rigid pipe element but may also have some flexibility. The outer insulation 3 is made from non-conductive material, like e.g., materials commonly used for the insulations of electrical cables or similar. It may also serve for protection against mechanical impacts.

The inner surface 21 of the electrical conductor 2 is provided with protrusions 22 to increase the heat transfer surface and thus enhance the heat transfer from the electrical conductor 2 to the dielectric coolant flowing through channel 24. In the embodiment shown the protrusions are realized in form of 64 elongated fins 23. However, this is only exemplary and other numbers of fins are likewise possible. The number of fins should be preferably at least 10, more preferably between 30 and 200, and even more preferably between 60 and 200.

The fins 23 have a triangular cross-section as seen in a plane perpendicular to the extension direction of the conductor 2 (which is the plane shown in FIG. 1). The fins protrude with their tips pointing inwards towards the interior of channel 24.

Additionally, in FIG. 1 the dimensions of the height of the fins, [dᵢ] of the inner diameter of the tubular electrical conductor 2 and of the thickness of the conductor wall 25 are indicated. The height with which the fins 23 protrude from the inner surface 21 of the electrical conductor 2 is in the embodiment shown about 0.8 mm. Generally, the height is preferably at least 0.2 mm, more preferably at least 0.4 mm, and even more preferably at least 0.6 mm.

The relation dᵢ/h between the inner diameter [dᵢ] of the tubular electrical conductor 2 and the height with which the linear fins 23 protrude from the inner surface 21 of the tubular electrical conductor 2 in the shown embodiment is approximately 40. Generally, the ratio is preferably between 8 and 100, more preferably between 10 and 75, and even more preferably between 10 and 50.

FIG. 2 shows the same embodiment of the high voltage power conductor assembly 1 as shown in FIG. 1 in an isometric view. In this figure it is visible that in the shown embodiment, the fins extend linearly in the extension direction of the conductor, i.e. they run parallel to the extension direction of the tubular conductor 2. However, while this is a preferred arrangement due to the advantages associated with the manufacturing thereof, other forms and orientations of fins or other protrusions are feasible.

While the invention has been described with reference to an exemplary embodiment(s), it will be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### Discussion of Possible Embodiments

The following are non-exclusive descriptions of possible embodiments of the present invention.

In some aspects, the techniques described herein relate to a high voltage power conductor assembly, including: a tubular electrical conductor having an inner surface with protrusions for increasing heat transfer, the inner surface defining a channel configured for receiving a coolant from a cooling system designed to evacuate heat from the tubular electrical conductor to the coolant when in use; and an outer insulation surrounding the tubular electrical conductor.

The high voltage power conductor assembly of the preceding paragraph can optionally include, additionally and/or alternatively any, one or more of the following features/steps, configurations and/or additional components.

For example, at least part of the protrusions may be fins aligned in a direction of extension of the tubular electrical conductor.

For example, at least 10 fins may be disposed on the inner surface.

For example, between 30 and 200 fins may be disposed on the inner surface.

For example, between 60 and 200 fins may be disposed on the inner surface.

For example, a height at which the fins protrude from the inner surface of the tubular electrical conductor may be at least 0.2 mm.

For example, a relationship between an inner diameter of the tubular electrical conductor and a height with which the fins protrude from the inner surface of the tubular electrical conductor may be between 8 and 100.

For example, the fins may have a triangular cross-section.

For example, the high voltage power conductor assembly may include a coolant system and a coolant within the channel. The coolant system may be configured to allow the coolant to circulate within the channel to evacuate heat produced by the tubular electrical conductor in use.

For example, the inner surface of the tubular electrical conductor may be insulated.

For example, the coolant may include water and a glycol.

For example, the coolant may be a dielectric coolant.

For example, the coolant may be configured to circulate at a flow rate of at least 0.5 l/min.

For example, the coolant system may further include an inlet on a first end of the channel and an outlet on a second end of the channel. The inlet and the outlet may be configured to allow a steady flow of coolant.

For example, the inlet and/or the outlet may include means to selectively regulate a flow rate of the coolant.

For example, a wall thickness of tubular electrical conductor may be between 0.5 mm and 20 mm.

For example, the protrusions may be integrally formed with the tubular electrical conductor.

In some aspects, the techniques described herein relate to a method of cooling a high voltage power conductor assembly while charging a battery, including: providing a high voltage power conductor assembly including a tubular electrical conductor having an inner surface with protrusions for increasing heat transfer, the inner surface defining a channel configured for receiving a coolant from a cooling system designed to evacuate heat from the tubular electrical conductor to the coolant when in use and an outer insulation surrounding the tubular electrical conductor; connecting the tubular electrical conductor to a battery and an electricity source such that the battery can be charged; and connecting a coolant system such that a coolant can circulate within the channel and evacuate heat produced by the tubular electrical conductor.

The method of the preceding paragraph can optionally include, additionally and/or alternatively any, one or more of the following features/steps, configurations and/or additional components.

For example, the step of connecting the coolant system may further include connecting an inlet and an outlet of the channel to a coolant supply.

For example, the method may further include regulating a flow rate of the coolant to adapt it to a current flow in the tubular electrical conductor.

### LISTING OF REFERENCE NUMBERS

1 high voltage power conductor assembly
2 tubular electrical conductor
21 inner surface
22 protrusions
23 fins
24 channel
25 conductor wall
3 outer insulation
4 coolant

1. A high voltage power conductor assembly, comprising:
a tubular electrical conductor having an inner surface with protrusions for increasing heat transfer, the inner surface defining a channel configured for receiving a coolant from a cooling system designed to evacuate heat from the tubular electrical conductor to the coolant when in use; and
an outer insulation surrounding the tubular electrical conductor.

2. The high voltage power conductor assembly according to claim 1, wherein at least part of the protrusions are fins aligned in a direction of extension of the tubular electrical conductor.

3. The high voltage power conductor assembly according to claim 2, wherein at least 10 fins are disposed on the inner surface.

4. The high voltage power conductor assembly according to claim 3, wherein between 30 and 200 fins are disposed on the inner surface.

5. The high voltage power conductor assembly according to claim 3, wherein between 60 and 200 fins are disposed on the inner surface.

6. The high voltage power conductor assembly according to claim 2, wherein a height at which the fins protrude from the inner surface of the tubular electrical conductor is at least 0.2 mm.

7. The high voltage power conductor assembly according to claim 2, wherein a relationship between an inner diameter of the tubular electrical conductor and a height with which the fins protrude from the inner surface of the tubular electrical conductor is between 8 and 100.

8. The high voltage power conductor assembly according to claim 2, wherein the fins have a triangular cross-section.

9. The high voltage power conductor assembly according to claim 1, including a coolant system and a coolant within the channel, the coolant system being configured to allow the coolant to circulate within the channel to evacuate heat produced by the tubular electrical conductor in use.

10. The high voltage power conductor assembly according to claim 9, wherein the inner surface of the tubular electrical conductor is insulated.

11. The high voltage power conductor assembly according to claim 10, wherein the coolant comprises water and a glycol.

12. The high voltage power conductor assembly according to claim 10, wherein the coolant is a dielectric coolant.

13. The high voltage power conductor assembly according to claim 9, wherein the coolant is configured to circulate at a flow rate of at least 0.5 l/min.

14. The high voltage power conductor assembly according to claim 9, wherein the coolant system further includes an inlet on a first end of the channel and an outlet on a second end of the channel, the inlet and the outlet being configured to allow a steady flow of coolant.

15. The high voltage power conductor assembly according to claim 14, wherein the inlet and/or the outlet include means to selectively regulate a flow rate of the coolant.

16. The high voltage power conductor assembly according to claim 1, wherein a wall thickness of tubular electrical conductor is between 0.5 mm and 20 mm.

17. The high voltage power conductor assembly according to claim 1, wherein the protrusions are integrally formed with the tubular electrical conductor.

18. A method of cooling a high voltage power conductor assembly while charging a battery, comprising:
providing a high voltage power conductor assembly including a tubular electrical conductor having an inner surface with protrusions for increasing heat transfer, the inner surface defining a channel configured for receiving a coolant from a cooling system designed to evacuate heat from the tubular electrical conductor to the coolant when in use and an outer insulation surrounding the tubular electrical conductor;
connecting the tubular electrical conductor to a battery and an electricity source such that the battery can be charged; and
connecting a coolant system such that a coolant can circulate within the channel and evacuate heat produced by the tubular electrical conductor.

19. The method according to claim 18, wherein the step of connecting the coolant system further comprises connecting an inlet and an outlet of the channel to a coolant supply.

20. The method according to claim 18, wherein the method further comprises regulating a flow rate of the coolant to adapt it to a current flow in the tubular electrical conductor.
